(19) United States
(12) Patent Application Publication
(10) Pub. No.: US 2008/0116258 A1
(43) Pub. Date: May 22, 2008

(54) MULTI-PURPOSE PAYMENT CARD AND METHOD OF USING SAME

(76) Inventor: Larry J. Kane, Marion, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/552,651

(22) Filed: Oct. 25, 2006

(51) Int. Cl. G06K 5/00; G06K 19/06

(52) U.S. Cl. 235/380; 235/493

(57) ABSTRACT

A multi-purpose payment card has indicia on at least one side that provides membership information for a merchant and a magnetic strip on one surface. The multi-purpose card is issued by the merchant to a card carrier and information is provided on how to activate the payment function of the card. To activate the payment function the card carrier contacts a service provider and authorizes activation. The service provider issues a pin number to the card carrier and collects funds from the card carrier's bank account. The service provider provides an incentive to use the card by making a designated charitable donation for each transaction.

### BACKGROUND OF THE INVENTION

This invention relates to payment devices and more particularly to payment devices that serve both a financial and a non-financial purpose.

Payment cards are well known in the art and are issued by banks and other financial institutions. These cards usually require a surcharge and may be used at a number of retail outlets to purchase goods and services.

In addition to payment cards, a number of non-financial organizations issue membership, discount, and reward cards. These cards serve a non-financial purpose such as providing access to an organization, showing entitlement to discounts and rewards, and even showing proof of insurance.

As a result card carrying consumers are overwhelmed by the number of cards they must carry to serve these different purposes. With a wallet having limited space these cards compete for wallet space. Further, merchants are dependent upon banks for issuing payment cards which can be expensive. Therefore, a need exists in the art for a payment device that addresses these deficiencies.

An object of this invention is to provide a payment device that also satisfies a non-financial purpose.

Another object of the present invention is to provide incentives for using a multi-purpose payment device.

These and other objectives will be apparent to those skilled in the art based on the following written description.

### SUMMARY OF THE INVENTION

A multi-purpose payment device has a financial purpose and a non-financial purpose. As one example, a card has indicia on at least one side that provides membership information for a merchant and a magnetic strip on one surface. The multi-purpose card is issued by the merchant to a card carrier and information is provided on how to activate the payment function of the card. To activate the payment function the card carrier contacts a service provider and authorizes activation. The service provider issues a pin number to the card carrier and collects funds from the card carrier's bank account. The service provider provides an incentive to use the card by making a designated charitable donation for each transaction.

### BRIEF DESCRIPTION OF THE DRAWINGS

FIG. 1 is a schematic drawing of the environment of a multi-purpose payment card;

FIG. 2 is a flow diagram of a method for a multi-purpose payment card;

FIG. 3 is a top view of a multi-purpose payment card; and

FIG. 4 is a bottom view of a multi-purpose payment card.

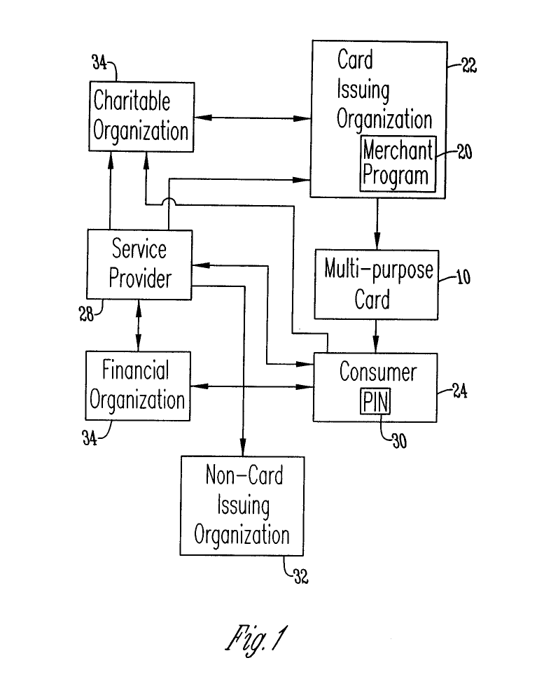

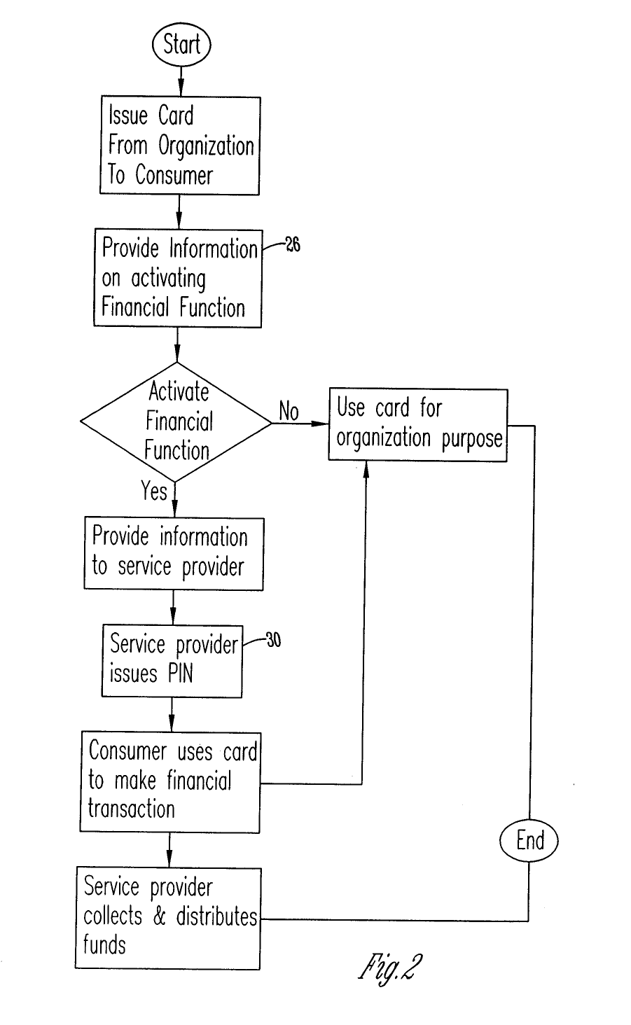

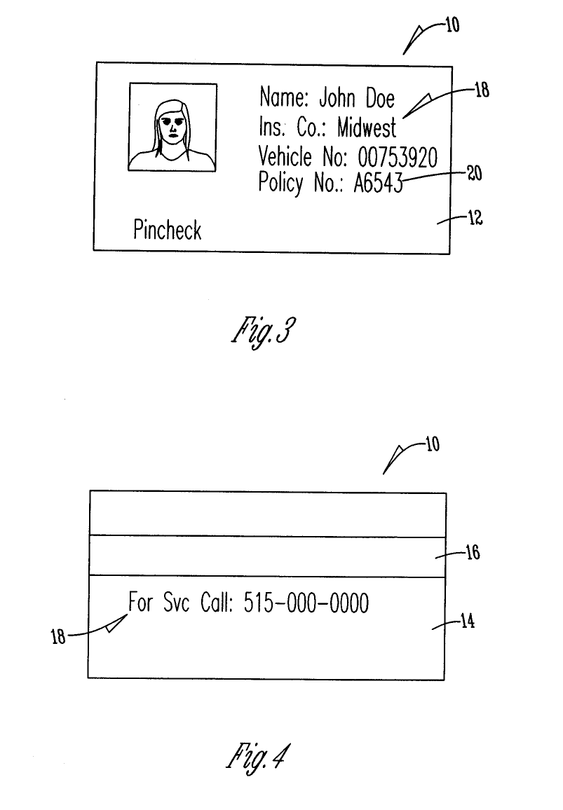

### DETAILED DESCRIPTION OF THE PREFERRED EMBODIMENT

Referring to the Figures a multi-purpose payment device is shown generally by reference numeral 10. The payment device 10 is of many types including debit cards, RFID card, key fobs and the like. Each of these multi-purpose payment devices 10 are capable of performing a financial function and a non-financial function. By way of example only, the present invention will be disclosed through an embodiment that utilizes a card having a magnetic strip. Other embodiments that included embedded chips, bar codes, and the like are also included within the scope of the device 10. The device/card 10 has a top or front surface 12 and a back or rear surface 14. On the back surface 14 is a memory device such as a magnetic strip 16. On at least the front surface is indicia 18 that relates to a merchant program 20. The term merchant program 20 refers to any non-financial service that is provided by an organization 22 for the benefit of a consumer 24. This could include indicia 18 including but no limited to a bar code indicating that the consumer 24 is a member of the organization 22; that the consumer 24 is entitled to discounts or rewards from the organization 22; or that the consumer 24 has satisfied certain requirements from the organization 22 such as having paid their insurance premiums and the consumers 24 insurance is in good standing. This information could also be stored in the magnetic strip 16.

In operation, the organization 22 issues the card 10 to the consumer 24 and provides information 26 on how to activate the payment function of the card. This information 26 is in any form including written, oral, or electronic. To activate the payment function of the card 10 the consumer 24 contacts a service provider 28 and provides the service provider with personal information (i.e., name, address, etc.), financial information (i.e., bank name, account number, etc.), and designates an entity for making donations (i.e., a charity).

Upon activation, the service provider 28 sends the consumer 24 a personal identification number 30 or code for use when making transactions. When a consumer 24 uses the card 10 for a financial transaction the consumer 24 enters the PIN 30 at the point of sale 32 and the service provider 28 verifies the transaction through conventional means. Once verified, the service provider 28 collects funds from the consumer's 24 financial institution 34 for payment to the point of sale merchant 32. As an incentive to issue the cards 10 to consumers the service provider 28 pays a rebate to the issuing organization 22 for all transactions made at a non-issuing point of sale merchant 32. This rebate could also be made to a designated worthy cause and/or charity 34.

As an incentive to encourage consumers 24 to use the card 10, a portion of the transaction amount is paid to a worthy cause 34 designated by the consumer 24.

From this disclosure a multi-purpose payment card has been disclosed that, at the very least, meets all the stated objectives.

1. (canceled)

2. (canceled)

3. (canceled)

4. (canceled)

5. A method of providing a multi-purpose debit card, comprising the steps of:
issuing a card from an organization to a consumer, the card having a magnetic strip and indicia on at least one surface relating to a merchant program;
activating a payment function on the card through a service provider wherein the service provider issues a personal identification number to the consumer, and
collecting funds from a consumer's financial organization when the consumer makes a verified transaction.

6. The method of claim 5 further
comprising the step of distributing a portion of the collected funds to a charitable organization designated by the consumer.

7. (canceled)

8. (canceled)

9. A method of providing a multi-purpose debit card, comprising the steps of:
issuing a card having a magnetic strip and indicia on at least one surface relating to a merchant program to a consumer;
activating a payment function on the card through a service provider wherein the service provider issues a personal identification number to the consumer;
collecting funds from a consumer's financial organization when the consumer makes a verified transaction; and
distributing a portion of the collected funds to a charitable organization designated by the consumer.

10. The method of claim 5 wherein a portion of the collected funds is distributed to the organization that issued the card.
